(19) United States
(12) Patent Application Publication
(10) Pub. No.: US 2023/0381974 A1
(43) Pub. Date: Nov. 30, 2023

(54) GRIPPER DEVICE

(71) Applicant: OKUMA Corporation, Niwa-gun (JP)

(72) Inventors: Mashun ITO, Niwa-gun (JP); Shoichi MORIMURA, Niwa-gun (JP)

(21) Appl. No.: 18/323,017

(22) Filed: May 24, 2023

(30) Foreign Application Priority Data
May 31, 2022 (JP) 2022-088775

(51) Int. Cl. B25J 15/02; B25J 15/10; B25J 15/08

(52) U.S. Cl. CPC B25J 15/0213; B25J 15/10; B25J 15/086

(57) ABSTRACT

A gripper device includes: an air cylinder having a piston rod; a rotary output mechanism which includes a screw shaft and a nut and which is configured to convert rectilinear motion of the piston rod into rotary motion; a plurality of linear motion units each having a gripper claw coupled thereto; and a rectilinear output mechanism which is configured to convert the rotary motion output from the rotary output mechanism into rectilinear motion and transmit the rectilinear motion to the plurality of linear motion units, and which includes a pinion gear and a rack gear. The nut is located at an inner diameter side of the pinion gear, and rectilinear stroke of the linear motion units is greater than rectilinear stroke of the piston rod.

### CROSS REFERENCE TO RELATED APPLICATION

The present invention claims priority under 35 U.S.C. § 119 to Japanese Patent Application No. 2022-088775 filed on May 31, 2022, the entire contents of which being incorporated herein by reference.

### TECHNICAL FIELD

The present specification discloses a gripper device for gripping a target object with a plurality of gripper claws.

### BACKGROUND

Conventionally, gripper devices are known that grip target objects by causing a plurality of gripper claws to advance and retreat rectilinearly. Such gripper devices are, for example, mounted on robots as end effectors, or provided inside a machining chamber of a machine tool.

Further, it is conventionally widely proposed to use an air cylinder as a source of motive power for causing gripper claws to advance and retreat. Here, there has been a problem that, in cases of employing an air cylinder with a long stroke for the purpose of increasing the stroke of gripper claws, the size of the overall gripper device becomes increased.

In view of this, there have been proposed techniques of increasing the stroke of the gripper claws by providing a plurality of gears between the air cylinder and the gripper claws. For example, Patent Literature 1 discloses a chuck device in which a pair of fingers (corresponding to gripper claws) are caused to advance and retreat using an air cylinder. In Patent Literature 1, a rack gear is formed on the piston of the air cylinder, and this rack gear is engaged with a main pinion gear. The main pinion gear is coupled to a driven pinion gear via a driven shaft. Further, the driven pinion gear is engaged with a driven rack gear provided on the pair of fingers. In this arrangement, in accordance with advance and retreat of the piston, the main pinion gear and the driven pinion gear are rotated, and the driven rack gear and the fingers are thereby caused to advance and retreat. Patent Literature 1 further discloses that, by forming the driven pinion gear to have a pitch diameter larger than that of the main pinion gear, the opening/closing stroke of the fingers can be increased compared to the stroke of the cylinder.

### CITATION LIST

### Patent Literature

PATENT LITERATURE 1: JP H3-82185 U

However, the technique of Patent Literature 1 cannot sufficiently downsize the gripper device. Specifically, in the configuration of Patent Literature 1, the main pinion gear, which converts rectilinear motion of the piston into rotary motion, and the driven pinion gear, which transmits the rotary motion to the driven rack gear, are arranged at positions considerably shifted from each other in the direction of the rotary axis. Here, the rotary axis of the main pinion gear and the driven pinion gear is parallel to the thickness direction of the chuck device. Therefore, according to the configuration of Patent Literature 1, the size of the chuck device in the thickness direction tends to become large.

In view of the above, the present specification discloses a gripper device in which size increase is suppressed while achieving sufficient stroke.

### SUMMARY

A gripper device as disclosed in the present specification includes: an air cylinder having a piston rod that advances and retreats rectilinearly; a rotary output mechanism which includes a screw shaft secured to the piston rod and a nut in threaded engagement with the screw shaft, and which is configured to convert rectilinear motion of the piston rod into rotary motion; a plurality of linear motion units configured to advance and retreat in synchronization with each other and each having a gripper claw coupled thereto; and a rectilinear output mechanism which is configured to convert the rotary motion output from the rotary output mechanism into rectilinear motion and transmit the rectilinear motion to the plurality of linear motion units, and which includes a pinion gear configured to rotate in synchronization with the nut and a rack gear engaged with the pinion gear. In the gripper device, the nut is located at an inner diameter side of the pinion gear, and rectilinear stroke of the linear motion units is greater than rectilinear stroke of the piston rod.

By configuring as above, it is possible to achieve sufficient stroke of the gripper claws by adjusting the lead of the screw shaft, the pitch circle diameter of the pinion gear, and the like. Further, since the nut is located at the inner diameter side of the pinion gear, the size of the gripper device and in particular, the size of the gripper device in the thickness direction (i.e., a direction orthogonal to the direction of opening/closing of the gripper claws), can be reduced.

In the gripper device, when m denotes module of the pinion gear, z denotes number of teeth of the pinion gear, and R denotes lead of the screw shaft, (π×m×z/R)>1 may be satisfied.

By configuring as above, the rectilinear stroke of the linear motion units can reliably be made greater than the rectilinear stroke of the piston rod.

In the gripper device, it may be configured such that: an axial direction of the piston rod, an axial direction of the screw shaft, an axial direction of the nut, and a rotary axis direction of the pinion gear are parallel to each other; the axial direction of the piston rod is orthogonal to a direction of rectilinear movement of the linear motion units; an axial extent occupied by the piston rod at least partially overlaps an axial extent occupied by the screw shaft; and the axial extent occupied by the screw shaft at least partially overlaps an axial extent occupied by the pinion gear.

By configuring as above, the size of the gripper device in the thickness direction can be further reduced.

According to the gripper device as disclosed in the present specification, size increase is suppressed while achieving sufficient stroke.

### BRIEF DESCRIPTION OF DRAWINGS

Embodiment(s) of the present disclosure will be described based on the following figures, wherein:

FIG. 1 is a perspective view of a gripper device in a closed state;

FIG. 2 is a perspective view of the gripper device in an open state;

FIG. 3 is a perspective view of the gripper device with its housing and protective cover removed;

FIG. 4 is a cross-sectional view of the gripper device in the closed state;

FIG. 5 is a cross-sectional view of the gripper device in the open state;

FIG. 6 is a cross-sectional view taken along line A-A in FIG. 4;

FIG. 7 is a cross-sectional view taken along line B-B in FIG. 5; and

FIG. 8 is a diagram illustrating a manner in which workpieces are stacked using the gripper device.

### DESCRIPTION OF EMBODIMENTS

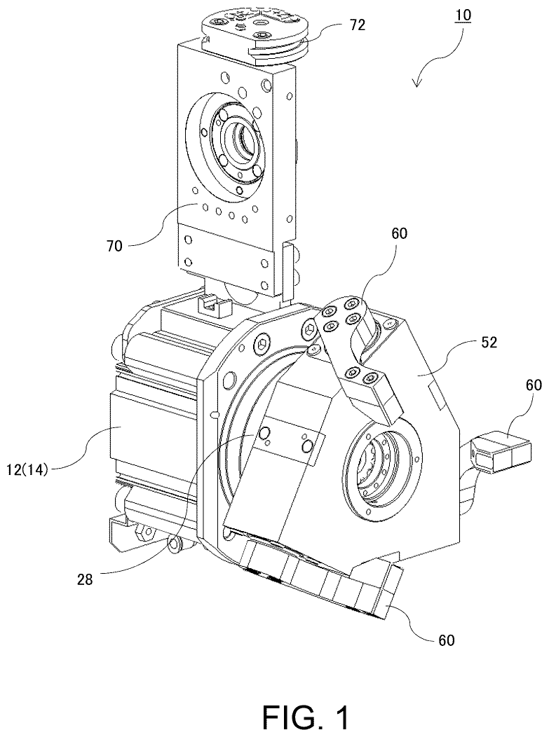

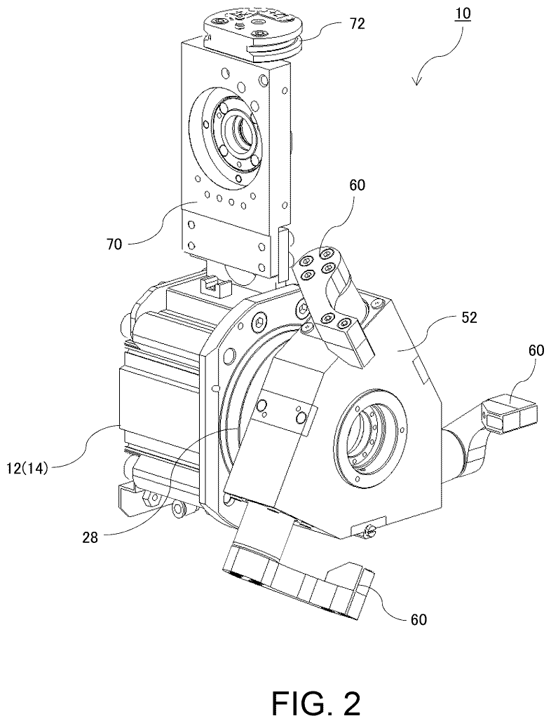

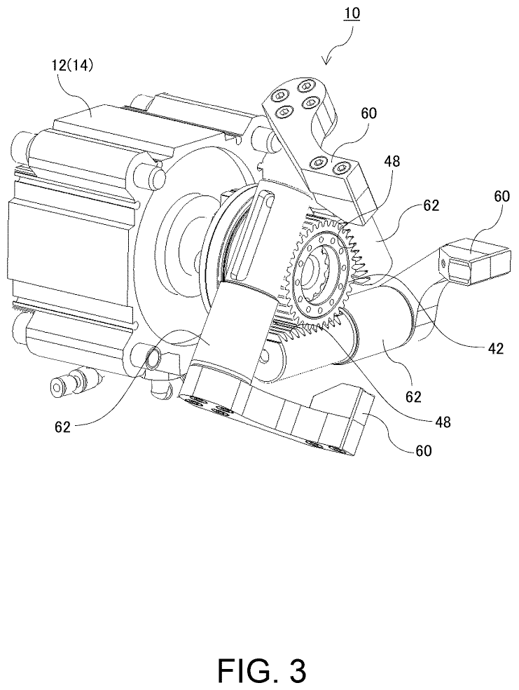

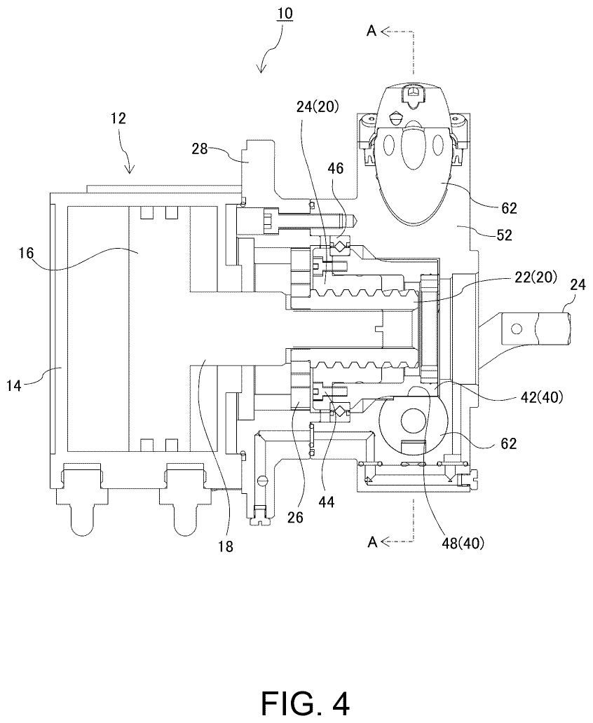

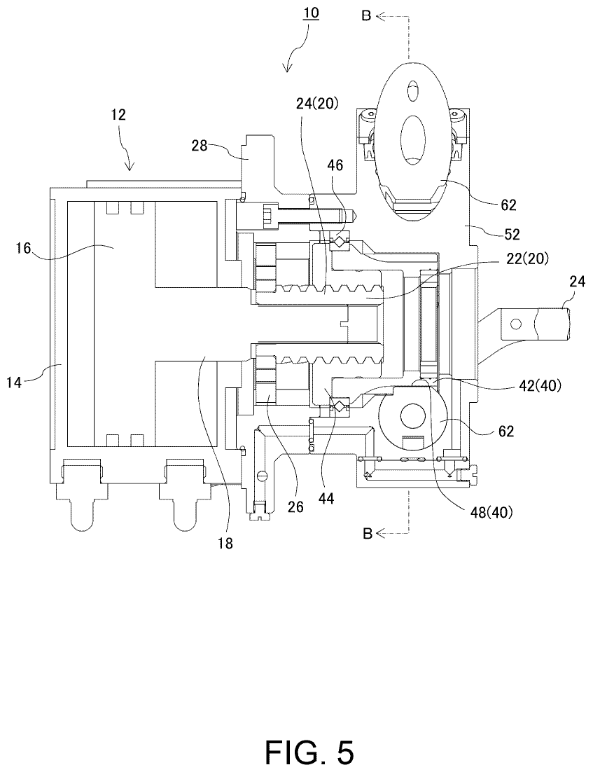

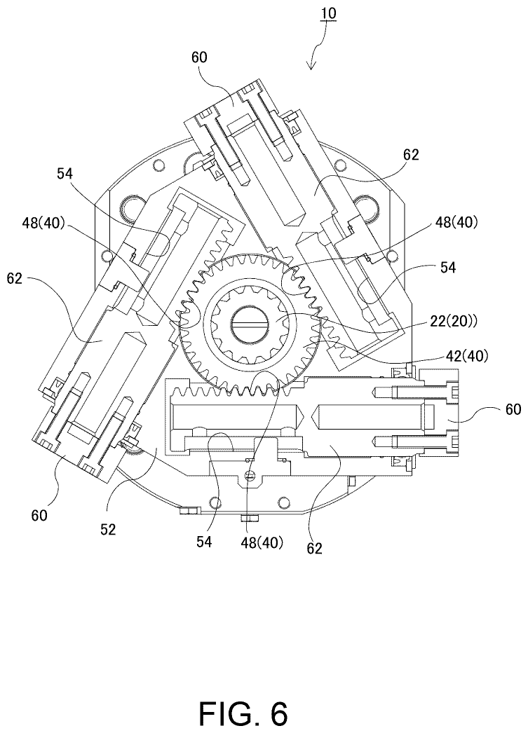

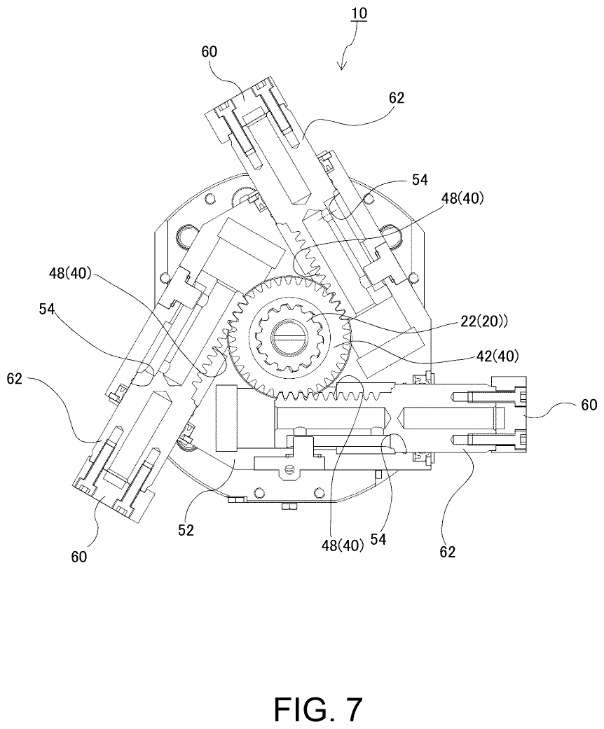

A configuration of a gripper device 10 will now be described with reference to the drawings. FIG. 1 is a perspective view of the gripper device 10 in a closed state, and FIG. 2 is a perspective view of the gripper device 10 in an open state. FIG. 3 is a perspective view of the gripper device 10 with its housing 28 and protective cover 52 removed. FIG. 4 and FIG. 5 are cross-sectional views of the gripper device 10. Further, FIG. 6 is a cross-sectional view taken along line A-A in FIG. 4, and FIG. 7 is a cross-sectional view taken along line B-B in FIG. 5.

The gripper device 10 according to the present embodiment comprises three gripper claws 60 located at angular intervals of 120 degrees and grips a target object by causing these three gripper claws 60 to advance and retreat rectilinearly with respect to each other. In the following description, a direction of advance/retreat of the gripper claws 60 is referred to as “the claw opening/closing direction”, and a direction orthogonal to the direction of advance/retreat of the three gripper claws 60 is referred to as “the thickness direction” of the gripper claws 60. The present gripper device 10 is, for example, mounted on an articulated robot as an end effector, or mounted on an actuator for transporting a cutting tool or a workpiece in a machine tool.

For the purpose of moving the three gripper claws 60, the gripper device 10 comprises an air cylinder 12, a rotary output mechanism 20, a rectilinear output mechanism 40, and linear motion units 62. The air cylinder 12 is the source of motive power for moving the gripper claws 60. As shown in FIG. 4 and FIG. 5, the air cylinder 12 comprises a cylinder tube 14, a piston 16 that advances and retreats rectilinearly inside the cylinder tube 14, and a piston rod 18 projecting from the piston 16 out of the cylinder tube 14. As in any general air cylinder, the piston 16 and the piston rod 18 are caused to advance and retreat rectilinearly by supplying air into the cylinder tube 14 or by discharging air from the cylinder tube 14.

The direction of advance/retreat of the piston rod 18 (i.e., the axial direction of the piston rod 18) is orthogonal to the direction of advance/retreat of the gripper claws 60 (and hence the axial direction of the linear motion units 62). In other words, the direction of advance/retreat of the piston rod 18 is parallel to the thickness direction of the gripper device 10.

A coupling unit 70 is secured to the circumferential surface of the cylinder tube 14. The coupling unit 70 is a part to be coupled to a robot or an actuator. A general joint mechanism is provided in the coupling unit 70. At an upper part of the coupling unit 70, a latching groove 72 is provided, which is used in maintaining the gripper device 10 in a suspended manner after removal from a robot or the like.

The rotary output mechanism 20 converts rectilinear motion of the piston rod 18 into rotary motion. This rotary output mechanism 20 comprises a screw shaft 22 and a nut 24. The screw shaft 22 is a shaft member having an external thread formed on its outer circumferential surface. A hole is formed penetrating through the screw shaft 22 in its axial direction, and a distal end of the piston rod 18 is inserted into and secured in this hole. Accordingly, the axial direction of the screw shaft 22 is parallel to the axial direction of the piston rod 18, and the screw shaft 22 advances and retreats rectilinearly together with the piston rod 18.

A rotation stopper 26 is secured to this screw shaft 22. On the outer circumferential surface of the rotation stopper 26, a plurality of projections (not shown in the drawing) are formed projecting outward in the radial direction, and grooves (not shown in the drawing) that receive these projections are formed on the inner surface of the housing 28. In other words, the rotation stopper 26 is engaged with the inner surface of the housing 28 in the circumferential direction. With this arrangement, the rotation stopper 26 and the screw shaft 22 are allowed to advance and retreat in the axial direction while being prevented from rotating.

The nut 24 is in threaded engagement with the external thread of the screw shaft 22. The nut 24 is coupled to the pinion gear 42 with connecting bolts 44, and the pinion gear 42 is supported by a bearing 46 so as to be rotatable with respect to the protective cover 52. Accordingly, the nut 24 is rotatable but is prevented from moving in the axial direction. Therefore, when the screw shaft 22 is caused to advance and retreat rectilinearly in the axial direction, the nut 24 rotates without moving in the axial direction. In other words, the nut 24 converts the rectilinear motion of the piston rod 18 into rotary motion.

The rectilinear output mechanism 40 converts the rotary motion output from the rotary output mechanism 20 into rectilinear motion and transmits the rectilinear motion to three linear motion units 62. This rectilinear output mechanism 40 comprises the single pinion gear 42 and three rack gears 48. As described above, the pinion gear 42 is a gear which is coupled to and rotates together with the nut 24. An axially penetrating hole is formed at the center of the pinion gear 42, and the nut 24, the screw shaft 22, and the piston rod 18 are partially located inside this hole. From a different perspective, it can be said that the nut 24 is located at the inner diameter side of the pinion gear 42.

As shown in FIG. 6 and FIG. 7, around the pinion gear 42, the three linear motion units 62 are arranged at angular intervals of 120 degrees. Each of the linear motion units 62 is a shaft-shaped member, and on its circumferential surface at a proximal end portion, a rack gear 48 is formed extending in the axial direction of the linear motion unit 62. The pinion gear 42 is engaged with the respective rack gears 48. Accordingly, when the pinion gear 42 is rotated, the rack gears 48, and hence the linear motion units 62, advance and retreat rectilinearly in the tangential direction of the pinion gear 42 (in other words, in the claw opening/closing direction). Inside the protective cover 52, guide holes 54 are formed, in which the linear motion units 62 are inserted. The linear motion units 62 advance and retreat rectilinearly by being guided by the guide holes 54.

A gripper claw 60 is attached at a distal end portion (i.e., an end portion located at a side opposite to the rack gear 48) of each of the linear motion units 62. Accordingly, by causing the piston rod 18 to advance and retreat rectilinearly, the nut 24 and the pinion gear 42 are rotated, and the linear motion units 62 and the gripper claws 60 are caused to advance and retreat rectilinearly.

As is apparent from the above description, in the present embodiment, the air cylinder 12 is used as the source of motive power for moving the gripper claws 60. With this feature, mounting and dismounting of the gripper device on a robot or an actuator is facilitated compared to when an electric or hydraulic motive power source is used. That is, the gripper device 10 of the present embodiment is envisioned to be used in a machining chamber of a machine tool, and typically, drops of cutting water and swarf are scattered inside a machining chamber. For this reason, if an electric motive power source is used, there is a risk that short circuits and corrosion may be caused at electric contacts by cutting water. Further, if a hydraulic motive power source is used, there would be a risk of hydraulic oil leakage and air intrusion in the hydraulic circuit. In contrast, when using a pneumatic motive power source employing the air cylinder 12, such problems do not occur, so that the pneumatic circuit can be connected easily.

One machine tool is typically used to handle workpieces of various sizes. Even when handling one workpiece, the shape of the workpiece is changed considerably from a raw material state before processing to a product state after processing. For this reason, the gripper device 10 to be used together with a machine tool is required to have a large stroke. Accordingly, in the present embodiment, the rectilinear stroke of the linear motion units is made greater than the rectilinear stroke of the piston rod 18 by adjusting the lead pitch of the screw and the module of the pinion.

Specifically, when S denotes the rectilinear stroke of the piston rod 18 and R denotes lead of the screw shaft 22, the rotational angle θn of the nut 24 is given by θn=2×π×S/R. Meanwhile, when m denotes the module of the pinion gear 42 and z denotes the number of teeth of the pinion gear 42, the rectilinear stroke L of the linear motion units 62 is given by L=m×z×θn/2=θ×m×z×S/R. Accordingly, in order to satisfy L>S, it is sufficient to satisfy (π×m×z×S/R)>S and hence (π×m×z/R)>1.

Here, (m×z) is the pitch circle diameter of the pinion gear 42. Accordingly, when it is desired, for example, to increase the stroke of the gripper claws 60 without changing the stroke S of the piston rod 18, this can be achieved by reducing the lead R of the screw shaft 22 or by increasing the pitch circle diameter of the pinion gear 42. Even when the pitch circle diameter is increased, size increase of the pinion gear 42 and hence size increase of the gripper device 10 can be suppressed to a small amount so long as the module m is small.

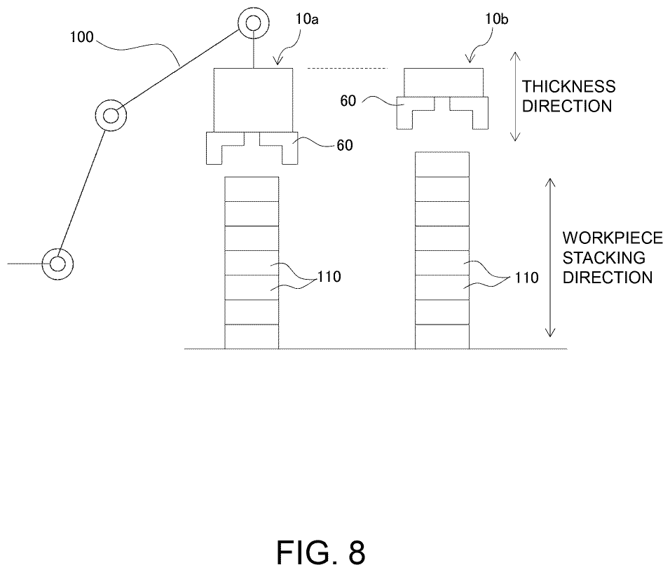

Further, the gripper device 10 is also required to be compact. In particular, in cases where the gripper device 10 is to be used in a machining chamber of a machine tool, if the gripper device 10 has a large size, there is a risk that the gripper device 10 may interfere with other components such as a spindle and a tool post. In addition, if the gripper device 10 has a large size in the thickness direction, there would be restrictions on operation of stacking workpieces. This point will be explained with reference to FIG. 8.

In a machine tool, there are cases where a plurality of workpieces 110 are to be stacked using a robot 100, as shown in FIG. 8. In such cases, the workpieces 110 are to be stacked in their thickness direction. The robot 100 has the gripper device 10 mounted thereon, and the gripper device 10 grips each workpiece 110 while in a position such that the thickness direction of the gripper device 10 and the thickness direction of the workpiece 110 are substantially parallel.

Here, as is apparent from a comparison of a gripper device 10a and a gripper device 10b shown in FIG. 8, the gripper device 10b having a smaller size in the thickness direction can position the gripper claws 60 higher in the stacking direction than the gripper device 10a having a larger size in the thickness direction. Accordingly, when the size of the workpieces 110 in the thickness direction is smaller, a greater number of workpieces 110 can be stacked.

In the present embodiment, in order to suppress the size of the gripper device 10 in the thickness direction, the nut 24 is provided at the inner diameter side of the pinion gear 42. From a different perspective, it can be said that, in the present embodiment, an axial extent occupied the nut 24 is configured to at least partially overlap an axial extent occupied by the pinion gear 42. Since the axial directions of the nut 24 and the pinion gear 42 are parallel to the thickness direction, by configuring the axial extents of these two components to overlap, the size of the gripper device 10 in the thickness direction can be suppressed. Furthermore, in the present embodiment, an axial extent occupied by the piston rod 18 is configured to at least partially overlap an axial extent occupied by the screw shaft 22, and the axial extent occupied by the screw shaft 22 is configured to at least partially overlap an axial extent occupied by the pinion gear 42. With this arrangement, the size of the gripper device 10 in the thickness direction can be further reduced.

The above-described configuration is simply one example, and changes may be made thereto as appropriate. For example, the number of the gripper claws 60 may be two, or may be four or more. The shape of the gripper claws 60 may also be changed as appropriate. Although the piston rod 18 and the screw shaft 22 are provided as separate components in the present embodiment, these two components may be combined into a single component. That is, an external thread that functions as the screw shaft 22 may be formed at a distal end portion of the piston rod 18. However, in that case, it would be necessary to produce a dedicated piston rod 18. Accordingly, when a general-purpose air cylinder 12 is to be used, it is appropriate to provide the piston rod 18 and the screw shaft 22 as separate components. With that configuration, it is easy to replace the air cylinder 12 with one having a different tube diameter in accordance with intended use, and gripping force of the gripper device 10 can thereby be changed easily. Furthermore, it is not necessary to configure the nut 24 and the pinion gear 42 as separate components, and teeth that function as the pinion gear 42 may alternatively be formed on the outer circumferential surface of the nut 24.

### REFERENCE SIGNS LIST

10 gripper device, 12 air cylinder, 14 cylinder tube, 16 piston, 18 piston rod, 20 rotary output mechanism, 22 screw shaft, 24 nut, 26 rotation stopper, 28 housing, 40 rectilinear output mechanism, 42 pinion gear, 44 connecting bolt, 46 bearing, 48 rack gear, 52 protective cover, 54 guide hole, 60 gripper claw, 62 linear motion unit, 70 coupling unit, 72 latching groove, 100 robot, 110 workpiece.

1. A gripper device, comprising:
an air cylinder having a piston rod that advances and retreats rectilinearly;
a rotary output mechanism which includes a screw shaft secured to the piston rod and a nut in threaded engagement with the screw shaft, and which is configured to convert rectilinear motion of the piston rod into rotary motion;
a plurality of linear motion units configured to advance and retreat in synchronization with each other, and each having a gripper claw coupled thereto; and
a rectilinear output mechanism which is configured to convert the rotary motion output from the rotary output mechanism into rectilinear motion and transmit the rectilinear motion to the plurality of linear motion units, and which includes a pinion gear configured to rotate in synchronization with the nut and a rack gear engaged with the pinion gear, wherein
the nut is located at an inner diameter side of the pinion gear, and
rectilinear stroke of the linear motion units is greater than rectilinear stroke of the piston rod.

2. The gripper device according to claim 1, wherein
when m denotes module of the pinion gear, z denotes number of teeth of the pinion gear, and R denotes lead of the screw shaft, (π×m×z/R)>1 is satisfied.

3. The gripper device according to claim 1, wherein
an axial direction of the piston rod, an axial direction of the screw shaft, an axial direction of the nut, and a rotary axis direction of the pinion gear are parallel to each other;
the axial direction of the piston rod is orthogonal to a direction of rectilinear movement of the linear motion units;
an axial extent occupied by the piston rod at least partially overlaps an axial extent occupied by the screw shaft; and
the axial extent occupied by the screw shaft at least partially overlaps an axial extent occupied by the pinion gear.
